(19) United States
(12) Patent Application Publication
(10) Pub. No.: US 2021/0070605 A1
(43) Pub. Date: Mar. 11, 2021

(54) Fuel Supply Can Adapter

(71) Applicant: Steven Brent, Northern Arm (CA)

(72) Inventor: Steven Brent, Northern Arm (CA)

(73) Assignee: Steven Gordon Brent, Northern Arm, NL (CA)

(21) Appl. No.: 16/561,114

(22) Filed: Sep. 5, 2019

(51) Int. Cl. B67D 7/42; B67D 7/04; B67D 7/76

(52) U.S. Cl. CPC B67D 7/42; B67D 7/76; B67D 7/04

(57) ABSTRACT

In most marine applications, an outboard boat motor is supplied fuel through a hose from an on-board fuel tank. Once the tank is near empty, it must be refilled to continue operation, a process that normally involves an additional fuel holding cell (such as a jerrycan or other fuel carrying cell). Refilling the boat's tank can often take place on rough open waters, meaning the pouring of fuel from a can into the tank can be a messy, potentially dangerous process. This invention allows for the safe usage of a standard fuel carrying container as a primary or overflow fuel source, by adapting the spout of the can into a format that is accepted by most outboard motor hardware configurations. It can be connected with minimal effort within a few minutes, filters fuel while it is being supplied, and bypasses the need for can-to-tank transfers.

This invention is a simplified way to adapt standard fuel carrying cans for use as direct filtered fuel sources for outboard boat motors.

Most outboard motors are supplied fuel through manufacturer-supplied hoses from holding tanks. In many cases, the desired quantity of fuel surpasses the capacity of the supplied tank, and additional fuel must be carried inside approved carrying cans for the purpose of refilling the manufacturer's tank, if required. Often, it is not ideal to transfer the fuel from the can into the tank, such as while in a boat over rough water.

This invention utilizes a feature of most standard fuel carrying cans: a threaded neck with a cover that allows for auxiliary passage through a central hole. The adapter fits through said hole and allows fuel to pass through and become filtered when the can's cover is secured. This means that the process of pouring fuel from the carrying can into the motor's supply tank can be completely bypassed, and fuel can be fed safely from the carrying can directly.

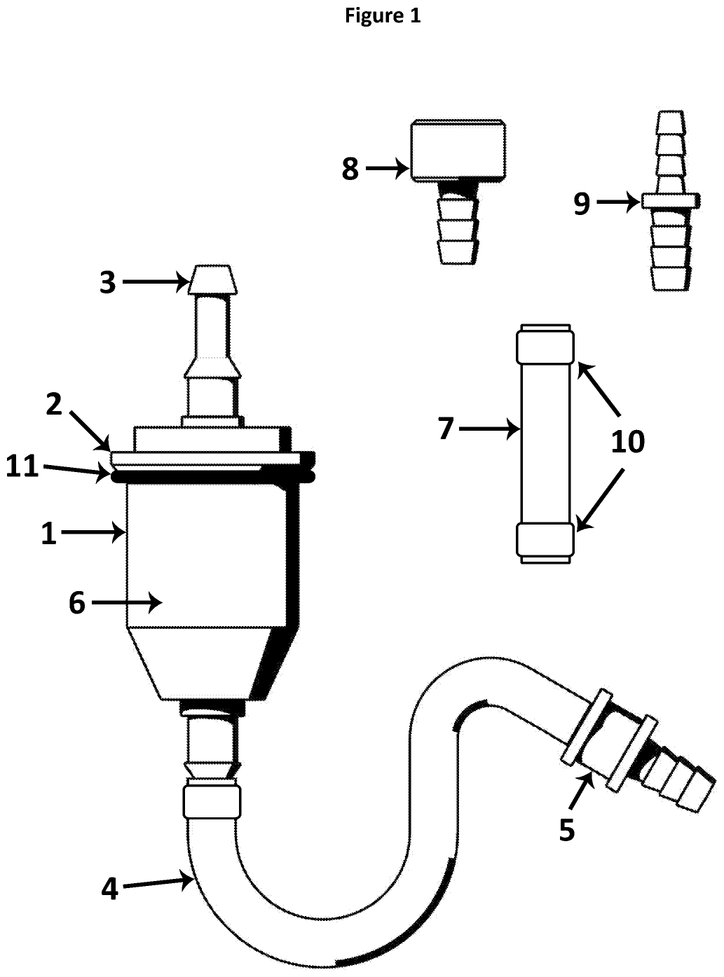

Referring to FIG. 1, which is a side view of the entire adapter assembly:
1 is an inline fuel filter encasement that acts as a bung;
2 is a laterally-projecting flanged cap at the top of the bung 1 that prevents full insertion into the gas can, and is secured by the threaded cover of the gas can. It is sized to fit the most common size of can, and can sit on top of a large seal ring if placed in a gas can with a larger neck;
3 is an outlet spout at the top of the bung 1 that allows for coupling directly to the motor fuel line, or a fuel line adapter, including commercially available coupling components;
4 is a flexible inlet hose that extends all the way to the bottom of most standard-sized carrying cans, and is securely clamped to a concealed spout extending from underneath the bung 1. Its length in this depiction is not to scale;
5 is a check valve that prevents unwanted fuel leakage from the hose upon removal of the adapter from the gas can, and also provides sufficient mass to sink the inlet end of the hose beneath the fuel level inside the can;
6 is a nylon fuel filter that adds an extra layer of protection for motors through fuel filtration during use;
7 is an included, optionally installed adapter hose that allows for further adaptation. When in use, one end is clamped to the outlet spout of the bung 3 and secured with a provided hose clamp 10. The other end of the adapter hose clasps around the desired adapter mechanism, such as the size reducer 9 or threaded adapter 8, and is secured again with a hose clamp 10;
8 is an included, optionally installed threaded adapter compatible with commercially available coupling components, and when in use, is clamped into the adapter hose 7 and secured using a provided hose clamp 10;
9 is an included, optionally installed size reduction coupler used to connect the adapter to a smaller motor fuel supply line. When in use, it is clamped into the adapter hose 7 and secured using a provided hose clamp 10;
10 are optionally used hose clamps for securing the adapter hose 7, the threaded adapter 8 and/or the size reduction coupler 9.
11 is a rubber o-ring for providing a seal between the flange 2 of the bung 1 and the rim of the fuel can neck.

To use the adapter, the inlet hose 4 and check valve 5 are inserted into the fuel carrying can through the neck and secured with the can's cover by threading it on like normally while the rubber o-ring 11 seals the system. Next, depending on the exact specifications of the end user's configuration, the motor fuel supply line is connected in one of three manners: directly onto the outlet spout 3; onto the reduction coupler 9; or onto the threaded adapter 8. This completes the setup process, and the fuel can is ready for use as a temporary fuel tank.

This invention should be considered as limited only by the scope of the appended claims, and not specifically by the details contained solely in the preceding description.

1. For use in fuel carrying cans that have pouring necks, an adapter comprising of a cylindrical bung that fits snugly inside the necks of fuel carrying cans that allows for fuel passage through the center and includes a fuel filtering mechanism housed inside said bung.

2. An adapter as defined in claim 1 including having a check valve connected to the inlet end of the flexible fuel inlet hose to prevent fuel backtracking and to provide an adequate mass to overcome any buoyancy of the inlet hose end to keep it below the fuel level.
